(19) United States
(12) Patent Application Publication
(10) Pub. No.: US 2020/0327278 A1
(43) Pub. Date: Oct. 15, 2020

(54) INTEGRATED ADMISSION DATA MANAGEMENT SYSTEM USING BIG DATA ANALYSIS

(71) Applicant: EFM Inc., Seoul (KR)

(72) Inventor: Jaejin BAE, Seoul (KR)

(73) Assignee: EFM Inc., Seoul (KR)

(21) Appl. No.: 16/914,971

(22) Filed: Jun. 29, 2020

Related U.S. Application Data
(62) Division of application No. 16/704,344, filed on Dec. 5, 2019.

(30) Foreign Application Priority Data
Dec. 7, 2018 (KR) 10-2018-0156919

(51) Int. Cl. G06F 40/166; G06F 16/2458; G06F 40/106; G06Q 10/10

(52) U.S. Cl. CPC G06F 40/166; G06Q 10/105; G06F 40/106; G06F 16/2465

(57) ABSTRACT

Provided is an integrated admission data management system using big data analysis, which constructs not only quantitative factors, expressible and measurable in numerical values, but also qualitative factors, not expressible or measurable in numerical values, as big data. Respective applicants are provided with customized information regarding a college or university to which the applicant is applying, on the basis of both quantitative factors and qualitative factors. A student of a college or university, to which an applicant is applying, is matched with the applicant, so that a personal statement written by the applicant is edited in a customized manner.

### CROSS REFERENCE TO RELATED APPLICATION

This application is a divisional of U.S. patent application Ser. No. 16/704,344 filed on Dec. 5, 2019, which claims priority to Korean Patent Application No. 10-2018-0156919, filed in the Republic of Korea on Dec. 7, 2018, which is hereby incorporated by reference for all purposes as if fully set forth herein.

### BACKGROUND

### Field

The present disclosure relates to an integrated admission data management system using big data analysis. More particularly, the present disclosure relates to an integrated admission data management system using big data analysis, which constructs not only quantitative factors, expressible and measurable in numerical values, but also qualitative factors, not expressible or measurable in numerical values, as big data, provides respective applicants with customized information regarding a college or university to which the applicant is applying, on the basis of both quantitative factors and qualitative factors, and thus, allows a personal statement written by the applicant to be edited in a customized manner by matching a student of the college or university, to which an applicant is applying, with the applicant, or by a variety of other methods.

### DESCRIPTION

Recently, due to the introduction of the admissions officer system, not only curriculum grades, official test scores, student records, and test paper scores of an applicant, but also qualitative factors of the applicant, such as comparative activities, a letter of recommendation written by a teacher, and award records, are becoming factors by which the applicant is evaluated. In addition, one of the most important evaluation factors in the admissions officer system is a personal statement (or essay). The personal statement serves to provide various pieces of information regarding an applicant, such as a growth process, strong points, weak points, motivation for application, and aspiration, to a person in charge of admissions, for example, an admissions officer, of a college or a university (hereinafter, collectively referred to as a “college”) to which the applicant is applying, in order to appeal to the person in charge of admissions.

Accordingly, a person in charge of admissions, such as an admissions officer, of a college, determines whether or not an applicant is qualified for admission by evaluating quantitative factors, such as academic grades, official test scores, and student records, of the applicant, as well as qualitative factors, such as comparative activities, award records, a letter of recommendation written by a teacher, and a personal statement, of the applicant.

Since such a personal statement is a document written by an applicant, the personal statement may display the capability of the applicant in a manner that cannot be discovered from quantitative factors. In a situation in which the overall levels of quantitative factors of applicants have been set to be higher, the importance of a personal statement, which is substantial and attractive to appeal to an admissions officer, is gradually increasing. In addition, this practice is more prominent among applicants applying to international or foreign colleges, rather than among applicants applying to colleges within the Republic of Korea, because the importance of the personal statement tends to be greater in international colleges than in colleges within the Republic of Korea, under the admissions officer system.

However, it is not easy to write a personal statement to be substantial, coherent, and consistent with the leadership model that a person in charge of admissions desires. Most applicants are not fully aware of in which form a personal statement should be written, what contents the personal statement should contain, how to construct paragraphs, and how to effectively emphasize their strong points. It is difficult for even excellent applicants to write a personal statement, because they are not accustomed to applying for admission in this manner.

The high level of difficulty of writing, as well as the importance, of a personal statement has created a new market. Specifically, a personal statement writing market has been created, in which applicants wanting to write a high-level personal statement are consumers and persons skilled in writing of personal statements serve as providers. Such providers are generally admissions experts, whereas applicants are guided in private institutes while paying expensive tuition fees.

As a related-art solution for this, Korean Patent Application Publication No. 10-2016-0037296 discloses “Device for Providing Personal Statement Editing Service and Recording Medium in which Control Method and Computer Program thereof are Recorded.”

The related-art solution provides a device for providing a service of editing a personal statement comprised of a plurality of reference sentences. The device includes: a display displaying a type object for obtaining first reference sentence classification information indicating a type of a reference sentence and a characteristic object for obtaining second reference sentence classification information indicating characteristics of the reference sentence; a user input device obtaining a first user input on the basis of the type object and a second user input on the basis of the characteristic object; and a controller obtaining proposal reference sentence information on the basis of the first user input and the second user input.

The solution as described above may classify reference phrases appropriate for the writing of a personal statement, and may provide the appropriate reference phrases to the user at the request of the user, so that the user can write the personal statement.

However, the above-described device for providing a service of editing a personal statement only serves to mechanically provide referable phrases, but may not provide deep editing in such a manner that would be provided by skillful experts, which is problematic.

Accordingly, there is increasing demand for the development of an integrated admission data management system that can provide respective applicants applying to a college or university with customized information regarding the applying college and enable a personal statement written by the applicant to be edited in a customized manner by reflecting not only quantitative factors, expressible and measurable in numerical values, but also qualitative factors, not expressible or measurable in numerical values.

### BRIEF SUMMARY

Various aspects of the present disclosure provide an integrated admission data management system that can provide respective applicants applying to a college or university with customized information regarding the college by reflecting not only quantitative factors, expressible and measurable in numerical values, but also qualitative factors, not expressible or measurable in numerical values, on the basis of big data, and enable materials required for college admissions, such as a personal statement written by the applicant, to be edited according to the college in a customized manner by matching an expert specialized in the preparation for college admissions or a student of the college, to which the applicant is applying.

Also provided is an integrated admission data management system that can further provide an additional configuration allowing the respective applicants to determine, by him or herself, an expert for editing the personal statement of the applicant, so that the applicant can be provided with a high-level instruction for the personal statement.

Also provided is an integrated admission data management system that can classify editing experts, such as a student or a graduate of a college to which an applicant is applying, to have different levels and assign the editing experts with different editing fees depending on the levels, so that the experts are provided with different compensations depending on the degrees of satisfaction regarding the tasks of the experts, evaluated by the applicants, and the cumulative careers of the experts.

Also provided is an integrated admission data management system that can provide a draft text analysis method specialized for the editing of personal statements. The draft text analysis method can provide the respective experts with reference materials to use when editing a personal statement in the system and provide editing guidance by analyzing a draft personal statement written by an applicant.

Also provided is an integrated admission data management system that can include a screen splitting configuration, by which editing experts can be more easily provided with guidance.

According to an aspect, an integrated admission data management system using big data analysis may include: a subscription module including a student subscription part allowing an applicant to input student information, including a name of a college to which the applicant is applying, and academic grades, award records, comparative activities, and student records of the applicant, and an expert subscription part allowing a plurality of experts to respectively input expert information including a name of a college of the expert; a matching module matching one expert from among the plurality of experts with the applicant; an input module receiving a draft personal statement from the applicant; a draft providing module providing the draft personal statement to the expert matched with the applicant; an editing module receiving an edited personal statement, obtained by editing the draft personal statement, from the expert; and an edited document providing module providing the edited personal statement to the applicant.

In addition, the expert subscription part may include a portfolio input part receiving a portfolio from each expert among the plurality of experts, the portfolio including a plurality of previously-edited documents that the expert has edited in the past. The matching module may include: a list creating part creating an expert list including the expert information and the portfolios of the plurality of experts; a list providing part providing the expert list to the applicant; an editor selecting part allowing the applicant to select one expert among the plurality of experts included in the expert list; and a matching part assigning the selected expert to be an editor and matching the selected expert with the applicant.

In addition, the expert subscription part may further include: an editing level assigner assigns different editing levels to the plurality of experts, respectively, depending on amounts of the previously-edited documents input by the plurality of experts; and an editing fee assigner assigning different editing feeds depending on the editing levels. The list creating part may create the expert list including the expert information, the portfolios, and the editing fees of the plurality of experts. The system may further include a settlement module including: a collecting part collecting an editing fee in accordance with the editing level of the expert selected by the applicant; and an editing fee providing part providing a fee for a manuscript to the editor in response to the edited personal statement being input by the editor.

The settlement module may further include a postscript writing part receiving a numerical satisfaction score regarding the editor from the applicant who has received the edited personal statement. The editing level assigner may assign different editing levels to the plurality of experts, respectively, depending on the amounts of the previously-edited documents input by the expert and an average of overall satisfaction scores regarding the expert input to the present point in time.

The integrated admission data management system using big data analysis according to the present disclosure has the following characteristics:

1) The integrated admission data management system according to embodiments can provide respective applicants applying to a college or university with customized information regarding the applying college and enable a personal statement written by the applicant to be edited in a customized manner by reflecting not only quantitative factors, expressible and measurable in numerical values, but also qualitative factors, not expressible or measurable in numerical values.

2) The integrated admission data management system according to embodiments can further provide an additional configuration allowing the respective applicants to determine, by him or herself, an expert for editing the personal statement of the applicant, so that high-level editing desired by the applicant can be provided.

3) Editing experts can be classified to have different levels and different editing fees may be collected, depending on the levels of the experts, so that the experts are provided with different compensations depending on their levels.

4) The integrated admission data management system according to embodiments provides a draft text analysis method specialized for the editing of personal statements. The draft text analysis method can provide the respective experts with reference materials to use when editing a personal statement in the system and provide editing guidance by analyzing a draft personal statement written by the applicant.

5) The integrated admission data management system according to embodiments further includes a configuration able to display editing keywords in circles and then display the keywords on a split screen, so that the editing experts can be more easily provided with guidance.

### DESCRIPTION OF DRAWINGS

The above and other objects, features, and advantages of the present disclosure will be more clearly understood from the following detailed description, taken in conjunction with the accompanying drawings, in which:

FIG. 1 is a conceptual view illustrating a schematic configuration of a system according to embodiments;

FIG. 2 is a block diagram illustrating a basic configuration of the system according to embodiments;

FIG. 3 is a block diagram illustrating a specific configuration of the system according to embodiments;

FIG. 4 is a conceptual view illustrating a highlighting treatment according to embodiments;

FIG. 5 is a graph illustrating an example of a likelihood function according to embodiments; and

FIG. 6 is a conceptual view illustrating screen division and circle marking according to embodiments.

### DETAILED DESCRIPTION

Hereinafter, embodiments of the present disclosure will be described in detail with reference to the accompanying drawings. It should be understood that the accompanying drawings may not be drawn to scale, and the same elements may be designated by the same reference numerals, even though they may be used in different drawings.

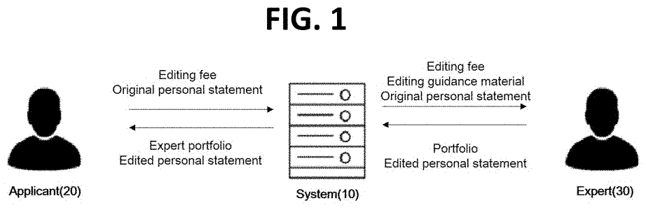

FIG. 1 is a conceptual view illustrating a schematic configuration of a system according to embodiments.

Hereinafter, an integrated admission data management system using big data analysis according to embodiments and components thereof will be described with reference to FIG. 1.

First, herein, applicants 20 mean persons applying for admission to a college or a university (hereinafter, collectively referred to as a “college”). The applicants 20 are subjects who must prepare various pieces of quantitative and qualitative data essential for admission to a college, in particular, admission to an international or foreign college, using a system 10 according to embodiments. For this purpose, each of the applicants 20 is required to select a college to which he or she is applying, insert quantitative factors, such as academic grades, official test scores, and student records, to a form provided by the system 10, and upload other data, such as records of comparative activities, award records, a letter of recommendation written by a teacher, and a draft personal statement, to the system 10.

Such data about individual applicants 20, uploaded as described above, may be constructed as big data in the system according to embodiments, while the confidentiality thereof is guaranteed.

Herein, experts 30 mean admission experts 30 specialized in the preparation for college admissions. In particular, the experts 30 may be students or graduates of colleges to which the applicants 20 are applying, instead of being instructors of private institutes, so that private educational expenses are reduced. In particular, the experts 30 according to embodiments may be persons having excellent skills in the preparation of personal statements and excellent consulting skills while being clearly aware of the characteristics, cultures, leadership models, and educational philosophies of corresponding colleges. The experts 30 not only review various pieces of data input by the applicants 20, but also edit personal statements that may be the most important factor by which admission is determined while being the final hurdle before admission.

The system 10 according to embodiments serves to relay information between the applicants 20 and the experts 30. In this regard, the system 10 according to embodiments serves to connect the applicants 20 to proper experts 30 while filtering data input by the applicants 20 and providing the filtered data to the experts 30. In addition, fees necessary for the editing of personal statements are paid via the system 10. The relaying operation of the system 10 enables editing fees to be transferred from the applicants 20 to the experts 30, thereby preventing fraud that could occur in transactions between individuals, unsatisfactory results of editing services, or the like. This also enables specialized editing to be performed at a high level. The system 10 is required to include a main server while being able to perform fundamental functions, such as information processing and information transfer. In addition to the basic information management as described above, the system 10 according to embodiments may have an additional function of providing a guidance material to the experts 30 to assist in editing, by analyzing quantitative and qualitative information (data) and draft personal statements input by the applicants 20. The additional function will be described later.

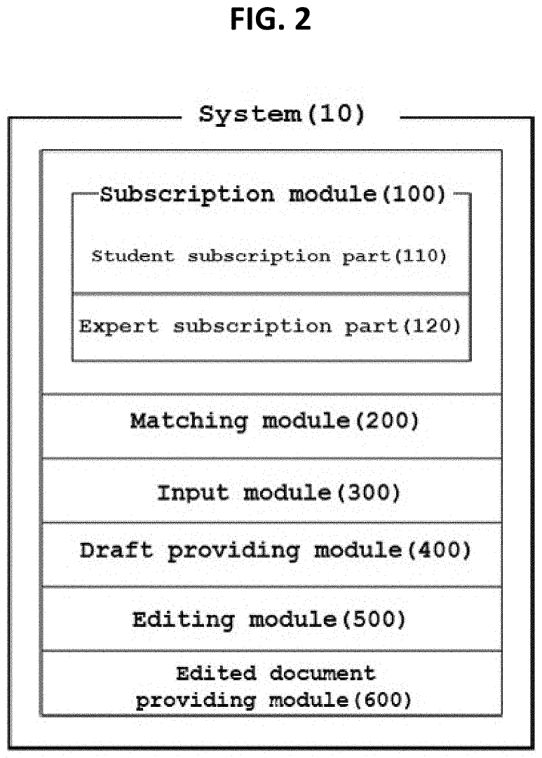

FIG. 2 is a block diagram illustrating a basic configuration of the system 10 according to embodiments.

Referring to FIG. 2, components included in the integrated admission data management system 10 according to embodiments will be described hereinafter. The system 10 according to embodiments should be able to treat not only quantitative factors, such as academic grades, official test scores, student records, and test paper scores, but also qualitative factors, such as comparative activities, a letter of recommendation, award records, and a personal statement. In particular, the editing of the personal statement (or an essay), which may be regarded to be the most important component, is performed, according to the basic criterion.

Thus, the system 10 according to embodiments includes a subscription module 100, a matching module 200, an input module 300, a draft providing module 400, an editing module 500, and an edited document providing module 600. The subscription module 100 allows the applicants 20 who want their personal statements to be edited and the experts 30 specialized in editing personal statements to subscribe to the system 10. The matching module 200 matches each of the applicants 20 with a pertinent expert among the experts 30. The input module 300 receives draft personal statements from the applicants 20 who want their personal statements to be edited. The draft providing module 400 provides the drafts of the personal statements to the experts 30 matched with the applicants 20. After the experts 30 have edited the drafts of the personal statements, the editing module 500 receives the edited personal statements. The edited document providing module 600 provides the edited personal statements to the applicants 20. The respective components will be described in more detail hereinafter.

First, the subscription module 100 is a module for registering the applicants 20 and the experts 30 in the system 10 by receiving information from the applicants 20 and the experts 30. The subscription module 100 includes a student subscription part 110 and an expert subscription part 120 to allow students and the experts 30 to input their information and subscribe to the system 10.

The student subscription part 110 receives basic information, such as the name, school, age, and gender, of the respective applicants 20 applying for admission to a college. In addition, information necessary for admission to a college, such as academic grades, award records, comparative activities, and student records, is input to the student subscription part 110. Furthermore, since the system 10 according to embodiments is intended to help the applicants 20 to be accepted by colleges to which the applicants 20 are applying, the student subscription part 110 receives the name of a college to which the respective applicants 20 are applying. Although the academic grades, the award records, the comparative activities, the student records, and the like may be directly input by the applicants 20, the system 10 (or the student subscription part 110 of the system 10) may work in concert with a database of a school of the respective applicants 20 so that the data is automatically transmitted to the system 10 from the database of the school of the respective applicants 20. The academic grades, the award records, the comparative activities, the student records, and the like may be created by scanning draft documents and then be transmitted to the system 10 via the student subscription part 110, instead of being directly input in the form of information.

Here, as described above, the quantitative/qualitative information and the personal statement, uploaded by an applicant, are stored in a database (DB) server separately provided in the system according to embodiments. The DB server according to embodiments may construct big data by collecting the information obtained from applicants. The DB server may determine the inclinations of the applicants on the basis of the big data constructed as above, perform comparative judgment on the applicants on the basis of the big data constructed as above, and classify the applicants into groups on the basis of big data analysis, so that the matching module, to be described later, may perform the matching more objectively and reasonably.

The expert subscription part 120 receives expert information, including experts' college information (i.e. information regarding the colleges of the experts), from the respective experts 30 specialized in the editing of personal statements and admission consultation. Here, the expert subscription part 120 receives basic information, such as the name, age, and gender, of the experts 30. The expert subscription part 120 may require the experts 30 to upload a certificate of student registration, a graduation certificate, a grade transcript, or the like, to prove the experts' college information. In this process, the expert subscription part 120 may use a program known in the art (e.g. Coalition or Naviance), by which the expert information may be automatically authenticated.

The matching module 200 serves to connect the applicants 20 and the experts 30 subscribed via the subscription module 100. Specifically, the respective applicants 20 are connected to a pertinent expert among the experts 30. This may be regarded as a function of assigning the expert 30 to edit a draft personal statement of the applicant 20. Here, the system 10 may automatically perform the matching operation by finding an expert among the experts 30, most suitable to the applicant 20. For example, a student or a graduate of a college, the name of which the applicant 20 has input as a college to which the applicant 20 is applying, may be selected as a matching expert when the academic grades, major, and comparative activities of the expert are determined to be suitable for the applicant 20. That is, an expert having a category similar to that of the applicant 20 may be found and automatically matched with the applicant 20. Alternatively, the applicant 20 may be allowed to select an expert from among two or more experts 30 (determined to be suitable for the applicant 20). This will be described in more detail later.

The input module 300 serves to receive a draft personal statement from the applicant 20 who has been matched with the expert 30. Here, the draft personal statement may be an outline of the personal statement written by the applicant 20. In addition, the draft personal statement may be input to the input module 300 by inputting the contents of the draft personal statement using a keyboard or the like or uploading a file of the draft personal statement written using a document writing program, such as Microsoft Word or Hancom Office Hangul. The personal statement may be uploaded using a cloud service or a shared platform service, such as Dropbox or Google Drive.

The draft providing module 400 serves to provide the draft personal statement, input by the applicant 20, to the expert 30 matched with the applicant 20, i.e. to the expert 30 selected to edit the draft personal statement. Here, if the draft personal statement is in a text form that the applicant 20 has input using the keyboard, the draft personal statement may be output on the display 40 so that the expert 30 (or editor) may review the draft on the display 40. If the draft personal statement is uploaded using a document writing program, the draft personal statement may be downloaded by the expert 30.

The editing module 500 allows the expert 30 who has received the draft personal statement to edit the draft personal statement and, after the draft personal statement has been edited, receives the edited personal statement. The edited personal statement may be input by inputting items and contents of the personal statement using a keyboard or uploading a file of the edited personal statement written using a document writing program, such as Microsoft Word or Hancom Office Hangul. Alternatively, in a case in which the draft personal statement is output on the display 40, the draft personal statement may be edited on the display 40 and, after the draft personal statement has been edited, the edited personal statement may be stored and uploaded. In addition, a temporary storage function serving as an intermediate step may also be included. Here, the edited personal statement is produced by reviewing and correcting the draft personal statement. Rewriting, i.e. ghostwriting, of the personal statement is not desirable. In addition, the editing module 500 may also provide a means of communication, such as a chat window, for the applicant 20 and the expert 30, so that the expert 30 can edit the personal statement more properly while communicating with the applicant 20.

The edited document providing module 600 serves to provide the edited personal statement, input by the expert 30, to the applicant 20 who uploaded the draft personal statement. The draft personal statement may be provided together with the edited personal statement, so that the applicant 20 can compare the draft personal statement, written by him or herself, with the edited personal statement reviewed and corrected by the expert 30.

Furthermore, when the edited personal statement is provided to the applicant 20, a template including the edited personal statement and student information, such as the name of the applying college, the academic grades, the award records, the comparative activities, and the student records, may be provided to the applicant 20. Guidance or consulting data edited by the expert 30 may be additionally provided to the applicant 20. The above-described pieces of information form a portfolio for the applicant 20, and may be significantly helpful to the applicant 20 intending to apply to a college within the Republic of Korea, under the school record-based student selection policy, or more desirably, to an international college.

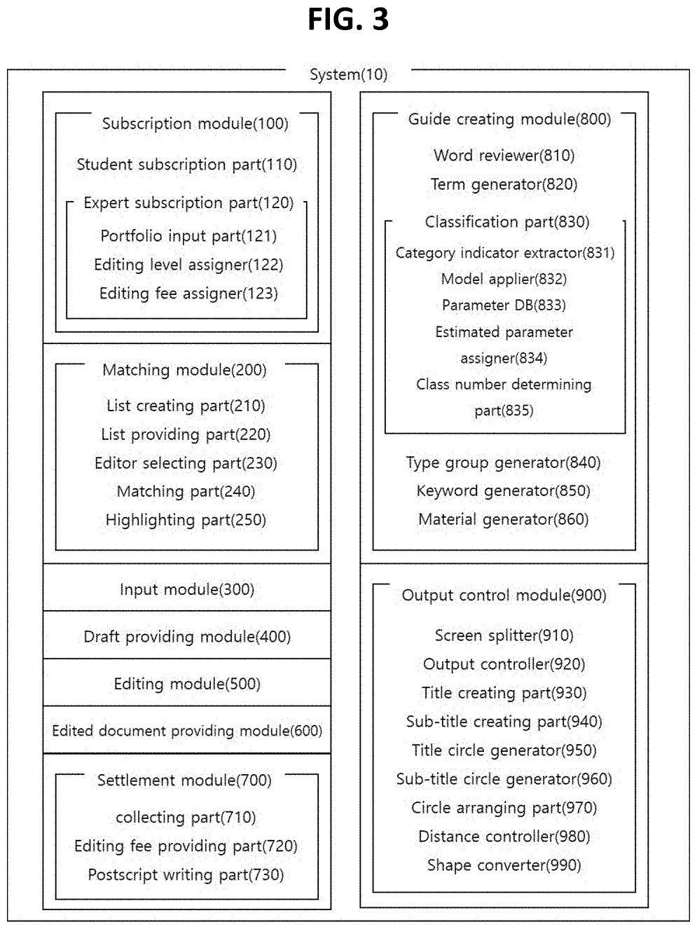

FIG. 3 is a block diagram illustrating a specific configuration of the system 10 according to embodiments.

Referring to FIG. 3, components and detailed components of the system 10 according to embodiments will be described hereinafter.

First, the matching module 200 of the system 10 according to embodiments has been described as serving to match the respective applicant 20 with the expert 30 for editing a personal statement. In the above description, the applicant 20 may select one expert from among two or more experts 30, and the selected expert 30 may be matched with the applicant 20. Additional components provided for this function will be described as follows.

To allow the applicant 20 to select one expert from among two or more experts 30, a component allowing the applicant 20 to be provided with detailed information regarding the experts 30 is required. Here, detailed information regarding the respective experts 30 may include the age, education, major, number of previous editing tasks, contents of previously-edited personal statements, and the like, of the expert. Accordingly, to provide the detailed information to the applicant 20, the expert subscription part 120 may include a portfolio input part 121, while the matching module 200 may include a list creating part 210, a list providing part 220, an editor selecting part 230, and a matching part 240.

The portfolio input part 121 of the expert subscription part 120 serves to receive a portfolio of the expert 30 from the expert 30. The portfolio may include a portion of the contents of previously-edited documents, i.e. personal statements previously edited by the expert 30. Thus, the previously-edited documents, i.e. the personal statements that have been edited by the expert 30 in the past, may be constructed as the portfolio according to the category. Here, the greater the number of the previously-edited documents is, the greater the amount of data in the portfolio is. This may also be stored in the DB server according to embodiments to be constructed as big data, thereby forming a progressive foundation for editing. Accordingly, this may increase the trust of the applicant 20, thereby increasing the possibility that the expert 30 could be selected.

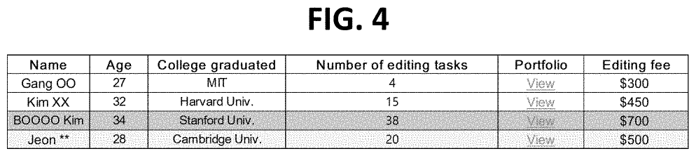

FIG. 4 is a conceptual view illustrating a highlighting treatment according to embodiments.

Describing the additional configuration of the matching module 200 with reference to FIGS. 3 and 4, the matching module 200 may create a list of experts (i.e. an expert list) with the list creating part 210. An example of the expert list is illustrated in FIG. 4. The expert list basically includes pertinent expert information (i.e. information regarding pertinent experts) and a portfolio corresponding to the pertinent expert information. That is, as illustrated in FIG. 4, the expert list may include a portfolio link, by which the name, college, major, and number of editing tasks of the pertinent expert 30, as well as documents previously edited by the pertinent expert 30, can be reviewed. Here, it is difficult to display the portfolio included in the expert list in a single window, since a plurality of previously-edited documents are included in the portfolio. Thus, as illustrated in FIG. 4, when a hyperlinked button “view” provided in the portfolio of the pertinent expert 30 is clicked, the previously-edited documents and consulting contents of the pertinent expert 30 may be displayed on the display 40 of the applicant 20.

The list providing part 220 serves to provide the created expert list to the applicant 20. Here, as illustrated in FIG. 4, the digitalized expert list may be output to the applicants 20 via a program or an application, installed in a PC, a smartphone, a tablet computer, a smart pad, or via the Internet. In addition, if the expert list is provided, the portfolio of the pertinent expert 30 may be reviewed. If the portfolio is reviewed, a fee may be collected in order to prevent the respective applicants 20 from reviewing the portfolio without requesting that his or her personal statement be edited.

The editor selecting part 230 serves to allow the applicant 20 to select a specific expert 30 from among the experts 30 in the expert list. In this regard, the editor selecting part 230 may allow the applicant 20 to select a specific expert 30 from among the experts 30 by selecting a selection button, which may be separately included in the expert list, or by inputting a code number assigned to the specific expert 30 or the name of the specific expert 30.

The matching part 240 serves to assign the expert 30, selected by the applicant 20, as an editor of the applicant 20 and match the selected expert 30 with the applicant 20. Thus, the matching part 240 may be the most basic configuration of the matching module 200. The selected expert 30 may be classified as an editor under the control of the system 10, so that the selected expert 30 is not selected for additional editing work unless the editing for the applicant 20 who selected the expert 30 is completed. The amount of work that the selected expert 30 can do may be limited. Alternatively, a single expert 30 may be assigned to be an editor of two or more students to edit a plurality of documents.

In addition, as described above, when the portfolios are input by the experts 30, the respective experts 30 may be evaluated on the system 10, so that the experts 30 may be assigned with grades.

Accordingly, the expert subscription part 120 may assign different editing levels to the experts 30 by an editing level assigner 122. Here, it may be appropriate that the editing levels are basically assigned according to the number, contents, or amount of the previously-edited documents input by the experts 30. This is because an expert who has edited a greater amount of documents can more rapidly and properly edit a personal statement than an expert who has edited a smaller amount of documents. Therefore, for example, a diamond level may be assigned to experts who have edited 100 or more times, a gold level may be assigned to experts who have edited 50 to 99 times, a silver level may be assigned to experts who have edited 30 to 49 times, and a bronze level may be assigned to experts who have edited 10 to 29 times.

When different editing levels are assigned to the experts 30 in this manner, different editing fees may be collected from the applicants 20, depending on the editing levels of the experts 30. In this regard, the expert subscription part 120 may set different editing fees according to the editing levels by an editing fee assigner 123. For example, 700 dollars may be set for the diamond level, 500 dollars may be set for the gold level, 300 dollars may be set for the silver level, and 200 dollars may be set for the bronze level. In addition to the fee schedule set by the system according to embodiments, a function of allowing the respective experts to individually set his or her editing fees may also be provided.

In the configuration of setting different editing levels and different editing fees according to the editing levels as described above, the expert list created by the list creating part 210 may include the portfolios and the editing fees of the pertinent experts 30.

In addition, since the pertinent configuration further includes a configuration for collecting editing fees, the system 10 should further include a configuration for collecting editing fees from the applicants 20 and paying fees to the experts 30 who have performed editing tasks. In this regard, a settlement module 700 is provided.

The settlement module 700 includes a collecting part 710. As one expert 30 in the expert list is selected by the applicant 20, the collecting part 710 allows the selected expert 30 to be paid an editing fee from the applicant 20, depending on the editing level of the selected expert 30. In this case, any available means of settlement, such as bank transfer, no-book deposit (or no-bankbook deposit), card payment, gift card payment, and mobile phone payment, may be used.

In addition, the settlement module 700 further includes an editing fee providing part 720. The editing fee providing part 720 provides a fee for a manuscript, based on the editing fee, to the expert 30, i.e. the editor, when it is confirmed that the expert 30 selected by the applicant 20 has completed the editing, i.e. it is confirmed that the edited personal statement has been input by the expert 30. Since the system 10 relayed the expert 30, i.e. the editor, and the applicant 20, the system 10 may deduct a commission from the editing fee when providing the fee to the expert 30.

In addition, in a case in which the respective applicants 20 are allowed to select an editor, i.e. a pertinent expert 30, while paying different editing fees depending on the editing level of the selected expert 30, the degree of satisfaction of the applicants 20 may be reflected in the editing level of the selected expert 30.

In this regard, the settlement module 700 may further include a postscript writing part 730. The postscript writing part 730 may allow the respective applicants 20 to input scores of satisfaction (hereinafter, referred to as “satisfaction scores”) for the editor who has edited the personal statement of the applicant after the editing of the personal statement is completed, i.e. after the edited personal statement is provided. The satisfaction scores may be displayed in numerical values. For example, a satisfaction survey function able to display a popup window or the like may provide a survey message “Are you satisfied with the editing of OOO expert 30?” to the respective applicants 20. The applicant 20 may input the degree of satisfaction in numerical values, ranging from 1 to 10 points. In this manner, the satisfaction survey can evaluate the degree of satisfaction.

In a case in which satisfaction scores are reflected as described above, it may be desirable that the satisfaction scores be reflected in the editing levels. The satisfaction scores of the applicants 20 are fed back to the experts 30 and reflected in the editing levels of the experts 30 in order to ensure that the experts 30 constantly output professional level results. In this regard, the editing level assigner 122 may assign different editing levels depending on an average of satisfaction scores input by a plurality of applicants 20, i.e. an average of overall satisfaction scores input to the present point in time, in addition to the number of previously-edited documents input by the expert 30. Accordingly, the experts 30 can more properly edit the documents, since the satisfaction scores input by the applicant 20 are directly reflected in the editing levels as described above.

In addition, since the experts 30 are assigned with different editing levels as illustrated in FIG. 4, some experts 30 having higher editing levels may be highlighted with different colors in the expert list. In this regard, the matching module 200 may include a highlighting part 250. The highlighting part 250 serves to impart the experts 30 in the expert list with different colors, depending on the editing levels of the experts 30. In the illustration of FIG. 4, it is apparent that experts “BOOOO Kim” and “Richard” having achieved higher number of editing tasks are highlighted with different colors. Here, the expert “BOOOO Kim” is colored to be more visually prominent. Such a treatment with different colors may allow the applicant 20 to recognize, at a glance, which expert 30 has edited more documents and whose editing level is higher, thereby assisting in the selection of the applicant 20.

Returning to FIG. 3, the description of the system 10 according to embodiments will be continued. The system 10 according to embodiments has been described as serving to relay the applicants 20 and the editing experts 30, and as being able to provide editing a guidance material to assist in actual editing of the editing experts 30. In this regard, the system 10 may further include a guide creating module 800. The guide creating module 800 of the system 10 may create the guidance material including a plurality of editing keywords, which may assist in the directing of the editing or should be emphasized in the editing, by automatically analyzing the draft personal statements input by the applicants 20. In a case in which the guidance material for editing is created in the system 10, the draft providing module 400 provides the draft personal statement, as well as the guidance material, to the expert 30 matched with the applicant 20.

Here, the basis function of the guide creating module 800 may be a function of analyzing the text of the draft personal statement and, furthermore, a function of extracting keywords from the text. In general, a class analysis method based on the analytic hierarchy process (AHP) has generally been used in keyword analysis. More particularly, it is more important to determine latent keywords not prominent in the draft personal statements than in the simple class analysis. This is because the applicant 20 may not sufficiently express or roughly describe a specific characteristic of him or herself while failing to find the importance of this characteristic, even in the case in which this characteristic is an important characteristic that should be highlighted, and this characteristic may determine whether or not the applicant can enter the applying college. Accordingly, the editing keywords may be generated by performing more detailed analysis on the basis of latent class analysis, and the guidance material including the editing keywords may be provided to the experts 30.

In this regard, the guide creating module 800 may include a word reviewer 810, a term generator 820, a classification part 830, a type group generator 840, a keyword generator 850, and a material generator 860. The respective components will be described in more detail hereinafter.

First, the word reviewer 810 reviews word information included in a text of the draft personal statement. Here, the system 10 according to embodiments will be described taking a case in which an English personal statement or an English essay is edited, since the personal statement is more focused on admission to an international college, as an example. It may be seen that English words include substantially no one-letter words, except for the article “a” or the personal pronoun “I”. Therefore, a criterion, on the basis of which word information included in a text is to be reviewed, may be to review a word composed of two or more letters as a single piece of word information. In addition, according to the basic criterion, punctuation marks, such as periods, quotation marks, and question marks, will be omitted unless explicitly described to the contrary, since such punctuation marks have substantially no effect on the analysis of the text. For example, from a sentence “I took him everywhere.”, three pieces of word information, including “took”, “him”, and “everywhere”, are reviewed and extracted.

The term generator 820 generates terms by filtering the word information extracted by the word reviewer 810. Here, the filtering basically performs normalization of the extracted word information. Here, no conversion (i.e. normalization) is required for pronouns, except for the personal pronoun, since pronouns are originally in a noun form. In this case, some words, such as prepositions (e.g. in, at, by, or above), will be omitted according to the basic criterion, since none of such words can be normalized. For example, the words “took”, “him”, and “everywhere” will be converted into “taking”, “he”, and “everywhere”. In addition, “me”, “mine”, and “my” will be normalized into “I”, “you” and “your” will be normalized into “you”, and “he”, “his”, and “him” will be normalized into “he”. Such personal pronouns do not have a significant effect on the analysis of the contents (or context) of the draft personal statement.

After the term generator 820 has normalized the word information extracted by the filtering of the personal pronouns, the other words, except for the personal pronouns, are extracted as terms. For example, when word information including, for example, “took”, “him”, and “everywhere”, are reviewed and extracted, only two terms “taking” and “everywhere” are extracted.

The classification part 830 serves to classify a plurality of terms into a plurality of classes by performing latent class analysis (LCA) on the plurality of terms generated by the term generator 820. Here, the LCA is a portion of a structural equation model, indicating the cause and effect and the correlation of latent variables. Here, since the latent variables are terms, the terms may be classified and categorized depending on the cause and effect and the correlation of the terms.

Since the terms classified by the LCA are groups estimated on the basis of similarity, the terms mainly used by the respective applicants 20 to write the draft personal statement and similar terms may be classified by such an LCA method, so that keywords to be used in the editing may also be determined by classification. In addition, in a case in which it is possible to perform typed judgment on the terms included in the text of the draft personal statement of the applicant 20, it is possible to determine whether or not the draft personal statement written by the applicant 20 is consistent with the leadership model of a specific college. Furthermore, in a case in which type analysis is performed on draft personal statements of applicants who have entered a specific college, it is possible to determine the types of the personal statements written by the applicants who have entered the specific college, and thus, to introduce the direction of the editing on the system 10.

Here, AHP-type class analysis that has been widely used for text analysis is based on clustering. Cluster analysis is a simple method of attempting classification on the basis of values of materials, and classification on the basis of coefficients estimated in a specific statistical method (e.g. typification on the basis of a rate of change estimated in the latent growth model) as in a mixed model is not possible. Since the LCA includes a variety of statistical indices, longitudinal analysis, influence variables, and result variables, by which the number of groups are determined, the LCA can be combined with various methods of analysis, and thus, may be regarded as a highest level of analysis method that is very strong and flexible.

The classification part 830 has been described above as performing the function of classifying and categorizing a plurality of terms. In this regard, the classification part 830 includes a category indicator extractor 831 and a model applier 832.

The category indicator extractor 831 serves to extract category indicators from the plurality of terms. The “category indicators” are words that can express the character, vision, and aspiration of the applicant 20. For example, terms expressing a character, such as “optimism”, “candor”, “honesty”, or “politeness”, or terms expressing a vocation, such as “layer”, “doctor”, or “dentist”, may be extracted as category indicators. That is, the extracted as category indicators may be terms that can express the character, vision, or aspiration of the applicant 20, or terms used to describe a vocation or an academic plan. More terms other than the above-specified words may be extracted as the category indicators. Here, it is apparent that the terms extracted as the category indicators are generated from the word information included in the draft personal statement.

The model applier 832 serves to classify the category indicators, extracted by the category indicator extractor 831, using a latent variable model. Since the determination of a class number and the determination of a parameter may be required in the latent variable model, a configuration for determining the class number and the parameter is further required. Therefore, for proper application of the model applier 832, it is necessary to determine the class number and the parameters using specific components of the classification part 830. In this regard, the classification part 830 may further include a parameter database (DB) 833, an estimated parameter assigner 834, a class number determining part 835.

The parameter DB 833 is a database storing parameters. The “parameters” may be frequency values by which pertinent terms occur in a text. However, it is difficult to find factors that are not prominent (i.e. do not frequently occur) in the text but should be determined to be important, on the basis of only the frequency values. Accordingly, the plurality of editing parameters may be input by the experts 30 and be stored in the DB in order to assist in the determination of parameters. For example, the input of an editing parameter may include an instruction, for example, “If the frequency of the term “candor” is 1 to 9, the frequency is corrected to be 20.” That is, this may generate the DB allowing the experts 30 to correct specific terms that are not prominent but should be emphasized, so that latent contents can also be analyzed.

The estimated parameter assigner 834 serves to extract a plurality of estimated parameters on the basis of the parameter DB 833 and the extracted terms and to determine the range of parameters depending on the number of extracted parameters. One value in the range of parameters is the number of classes to be categorized. Here, only the range of parameters is determined but the class number is not determined in advance in order to enable more exploratory and technical analysis of the text. It is intended to determine a pattern of behaviors of the applicant 20, i.e. a sentence writing pattern of the applicant 20, by inductively judging the data on the basis of the text. In addition, since the model is sufficiently verified during the determination of the class number, accurate analysis is possible even in the case in which the class number is not set in advance.

Here, the extraction of estimated parameters is to extract estimated classes. In this case, not only the number of frequency of the respective terms extracted, but also the number of frequency of the terms corrected by the parameter DB 833, is included. Thus, a plurality of parameters estimated to be categorized into classes are extracted, on the basis of not only the frequency of the occurrence of the terms, but also the terms corrected by correction formulas included in the parameter DB 833.

For example, it may be assumed that terms, including “optimism”, “candor”, “honesty”, and “politeness”, have been generated. “Optimism” occurred 5 times, “candor” occurred 1 time, “honesty” occurred 10 times, and “politeness” occurred 3 times. In addition, in a case in which the frequency of an editing parameter “If the term “candor” is 1 to 9, the frequency is corrected to be 20” is input, the frequencies of the terms are corrected. Specifically, the frequency of “optimism” is corrected to be 5, the frequency of “candor” is corrected to be 20, the frequency of “honesty” is corrected to be 10, and the frequency of “politeness” is corrected to be 3. Here, all of “candor”, “honesty”, and “politeness” are similar terms implying honesty. Thus, the minimum number of estimated parameters is two (2) by including “honesty”, which is representative from among “optimism”, “candor”, “honesty”, and “politeness”, whereas the maximum number of estimated parameters is 4. Therefore, the range of parameters is determined to be between 2 and 4. (In this example, this value of range is related to a significantly small number of terms. The range of parameters may be greater in an actual personal statement in which a greater amount of text is included.)

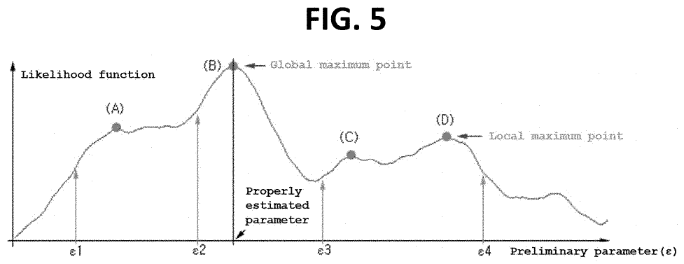

FIG. 5 is a graph illustrating an example of a likelihood function according to embodiments.

Referring to FIGS. 3 and 5, the class number determining part 835 serves to calculate an Akaike information criterion, a Bayesian information criterion, a modified Bayesian information criterion for each of integers included in the range of parameters, compare the calculated criteria, and assign one value in the range of parameters to be the class number. As described above, the class number is determined to be in a range, instead of being calculated in advance, and a most suitable value is determined to be the class number by applying an actual model. Here, more particularly, the integers included in the range of parameters are assigned to be preliminary parameters, respectively. The Akaike information criterion, Bayesian information criterion, and modified Bayesian information criterion are calculated for the preliminary parameters, respectively. Calculated values are analyzed, so that an integer indicating a value closest to an estimated maximum likelihood value with respect to an input integer is assigned to be the class number.

In this regard, it is necessary to calculate the estimated maximum likelihood value. The estimated maximum likelihood value may be calculated by following Formulas 1 and 2:

$$L ( ɛ x ) = ( \begin{matrix}n \\ x\end{matrix} ) {{ɛ}^{x} ( 1 - ɛ )}^{n - x} \qquad ( 1 )$$

(where x indicates an exponent assigned to a term “a”, L(εx) indicates a likelihood function for the component x and a preliminary parameter s, s indicates one of numbers included in the range of parameters, i.e. a preliminary parameter, and n indicates a total number of terms.)

E=x/n (2)

(where E indicates an estimated maximum likelihood value, x indicates an exponent assigned to the term “a”, and n indicates the total number of terms.)

Describing in more detail, the exponent assigned to the term “a” means a value obtained by correcting the term with a correction parameter, in addition to the number of frequency of the term. That is, as described above, when “optimism” occurred 5 times, “candor” occurred 1 time, “honesty” occurred 10 times, and “politeness” occurred 3 times, the frequencies of the respective parameters are corrected to be 5, 20, 10, and 3, respectively. In addition, a total number of the terms indicates a total number of the terms extracted from the text of the draft personal statement. In addition, in this case, a correction value should be considered, and thus, the total number of the terms is 38, since the frequency of “optimism” is corrected to be 5, the frequency of “candor” is corrected to be 20, the frequency of “honesty” is corrected to be 10, and the frequency of “politeness” is corrected to be 3, as described above.

Here, it may be difficult to calculate the likelihood function by a general method. Therefore, a statistical program may be used to calculate the likelihood function. For this purpose, a statistical program, such as MPlus, may be used. An example of the likelihood function, realized by statistics, is illustrated in FIG. 5. In the likelihood function, a general purpose is to obtain a maximum value. In this case, as a desirable maximum value to be extracted, the preliminary parameter may be small and the likelihood function may be large.

In addition, the class number determining part 835 assigns the integers included in the range of parameters as the preliminary parameters, respectively, calculates an Akaike information criterion, a Bayesian information criterion, a modified Bayesian information criterion, and analyzes the calculated values, thereby assigning an integer, indicating a value closest to an estimated maximum likelihood value with respect to an input integer, to be the class number. Here, respective calculation formulas are as follows:

First, the Akaike information criteria are calculated by Formula 3:

AIC=−2 log L(εx)+2ε (3)

The Bayesian information criteria are calculated by Formula 4:

BIC=−2 log L(εx)+ε log(n) (4)

The modified Bayesian information criteria are calculated by Formula 5:

$$a . BIC = - 2 log L ( ɛ x ) + ɛ \times \frac{n + 2}{24} \qquad ( 5 )$$

(where AIC indicates Akaike information criteria, BIC indicates Bayesian information criteria, a.BIC indicates modified Bayesian information criteria, x indicates an exponent assigned to a term “a”, L(εx) indicates a likelihood function for the component x and a preliminary parameter s, s indicates one of numbers included in the range of parameters, i.e. a preliminary parameter, and n indicates a total number of terms.)

Described in more detail, the exponent assigned to the term “a” means a value obtained by correcting the term with a correction parameter, in addition to the number of frequency of the term. That is, as described above, since “optimism” occurred 5 times, “candor” occurred 1 time, “honesty” occurred 10 times, and “politeness” occurred 3 times, the frequencies of the respective parameters are corrected to be 5, 20, 10, and 3, respectively. In addition, a total number of the terms indicates a total number of the terms extracted from the text of the draft personal statement. In addition, in this case, a correction value should be considered, and thus, the total number of the terms is 38, since the frequency of “optimism” is corrected to be 5, the frequency of “candor” is corrected to be 20, the frequency of “honesty” is corrected to be 10, and the frequency of “politeness” is corrected to be 3, as described above.

The three types of information criteria are calculated and the values thereof are compared in order to determine which model is most suitable as a first reason. In addition, since the respective information criteria impart different penalties depending on the number of parameters and the number of samples, all of the three types of information criteria imparting different penalties are calculated and compared. Consequently, an information criteria model having a likelihood value closest to the estimated maximum likelihood value with respect to an arranged integer value among the calculated information criteria is determined to be the most suitable information criteria model. Then, the value of the pertinent integer is assigned to be the class number.

In addition, it may be difficult to obtain the respective information criteria. Thus, a statistical program may be used to calculate the respective information criteria. For this purpose, a statistical program, such as MPlus, may be used.

Therefore, when the number of classes is assigned by the above-described configuration, the classification may be performed by the model applier 832. Here, the classification is enabled by following Formula 6:

P(yₐ=1)=Σ_{z=1}^{Z}=P(c=Z)P(yₐ=1c=Z) (6)

(where yₐ indicates a vector of a dependent variable for the term “a”, c indicates a class mark of an extracted category indicator, z indicates a respective class, and Z indicates a class number determined by the class number determining part 835.)

Here, the class mark indicates the corrected frequency of occurrence. The class number is calculated by above-described Formulas 1 to 5. In addition, if a statistical program, such as MPlus, is used when the above-described latent variable model is applied, those having ordinary knowledge in the art may readily use the latent variable model.

Accordingly, high-accuracy classification can be performed by the comparison on the basis of a variety of models and by determining the class number on the basis of the comparison, and thus, a value that is not offset can be obtained. In addition, as described above, the terms classified by the LCA are groups estimated on the basis of similarity. The terms mainly used by the respective applicants 20 to write the draft personal statement and similar terms may be classified by such an LCA method, so that keywords to be used in the editing may also be determined by classification. In addition, when it is possible to perform typed judgment on the terms included in the text of the draft personal statement of the applicant 20, it is possible to determine whether or not the draft personal statement written by the applicant 20 is consistent with the leadership model of a specific college. Furthermore, in a case in which type analysis is performed on draft personal statements of applicants who have entered a specific college, it is possible to determine the types of the personal statements written by the applicants who have entered the specific college, and thus, to introduce the direction of the editing on the system 10.

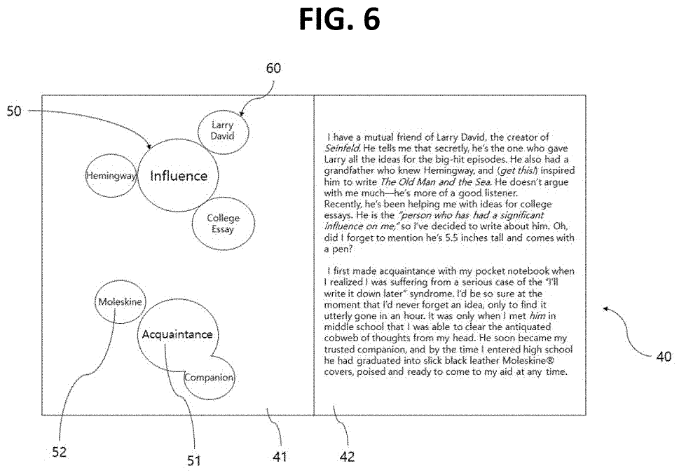

FIG. 6 is a conceptual view illustrating screen division and circle marking according to embodiments.

Describing with reference to FIGS. 3 and 6, when the draft personal statement is displayed on the display 40, the system 10 according to embodiments can correct the output draft personal statement, and when the correction is completed, can store and upload the corrected personal statement as an edited personal statement. In addition, the system 10 according to embodiments can not only match the applicants 20 with the experts 30, but also can analyze a draft personal statement and provide an editing guidance material to the experts 30.

According to an additional configuration for this purpose, the system 10 according to embodiments may be configured to split the screen of the display 40 of the respective experts 30, so that the draft personal statement is displayed on one area of the split screen, and editing keywords included in the guidance material are displayed on the other area of the split screen. In this regard, the system 10 may further include an output control module 900. The output control module 900 includes a screen splitter 910 and an output controller 920.

The screen splitter 910 serves to split the screen of the display 40 of the expert 30 into a first area 41 on which the guidance material is displayed and a second area 42 on which the draft personal statement is displayed. Accordingly, the screen of the display 40 is split into the two areas, i.e. the first area 41 and the second area 42. Although the shapes of the first area 41 and the second area 42 is not specifically limited, the entire area of the display 40 may be halved in a vertical direction or a horizontal direction to be equally split into the first area 41 and the second area 42.

The output controller 920 serves to differentially output one or more keywords, from among the editing keywords included in the guidance material, on the first area 41, depending on the contents of the draft personal statement. It may be inappropriate to output all of the draft personal statement on the second area due to a great number of words of the draft personal statement. Thus, editing keywords corresponding to a piece of content of the draft personal statement, output on the second area 42 at the current point in time, may be displayed on the first area 41, so that the expert 30 can more effectively review the keywords.

In addition, the generated editing keywords may be comprised of title keywords 51 and sub-title keywords 62. The title keywords 51 may be main and more important subjects. Thus, the output control module 900 can not only output the editing keywords, but also can divide the editing keywords into the title keywords 51 and the sub-title keywords 62 and express the title keywords 51 and the sub-title keywords 62 to be more visually recognizable at a glance. In this regard, the output control module 900 may further include a title creating part 930, a sub-title creating part 940, a title circle generator 950, a sub-title circle generator 960, and a circle arranging part 970.

The title creating part 930 serve to assign one or more keywords, from among the plurality of editing keywords, to be the title keywords 51. The sub-title creating part 940 serve to assign other editing keywords, related to the title keywords 51, to be the sub-title keywords 62. Here, a method of assigning the title keywords 51 and the sub-title keywords 62 may basically depend on the frequency of the terms. Most desirably, the editing keywords having highest frequencies in the text of the draft personal statement output on the second area 42 may be assigned to be the title keywords 51, while other editing keywords related to the title keywords 51 (i.e. editing keywords classified to be in the same class in the above-described latent variable model) may be assigned to be the sub-title keywords 62. The title keywords 51 and the sub-title keywords 62 may also be assigned by another method.

The title circle generator 950 serves to generate title circles 50 in the shape of closed circles, in which the title keywords 51 are displayed, respectively. The sub-title circle generator 960 serves to generate sub-title circles 60 attached to the title circles 50. The sub-title circles 60 also have the shape of closed circles, in which the sub-title keywords 62 are displayed. Since the sizes of the sub-title circles 60 are essentially smaller than the sizes of the title circles 50, the expert 30 can visually recognize, at a glance, that the importance of the sub-title keywords 62, displayed in the sub-title circles 60, is lower than the importance of the title keywords 51, displayed in the title circles 50. In addition, the configuration of the title circles 50 and the sub-title circles 60 as described above can not only show the organic relationship between the pertinent title and sub-title keywords 51 and 62, but also can be provided in the form of an abstract of the editing keywords.

The title circles 50 and the sub-title circles 60 are displayed on the first area 41 by the circle arranging part 970. The circle arranging part 970 serves to display the title circles 50 and the sub-title circles 60, attached to the title circles 50, on the first area 41, in which the title circles 50 and the sub-title circles 60 are related to the contents of the draft personal statement displayed on the second area 42. In addition, when the title circles 50 and the sub-title circles 60 are clicked, the frequencies of occurrence of the title keywords 51 and the sub-title keywords 62, corresponding to the circles pressed, may be displayed. Synonyms having substantially the same meanings may also be displayed on a popup window or the like, so as to be visually recognized by the expert 30. In addition, sub-circles may further provided at a side of the sub-title circles 60. In this case, more detailed classification is performed by attaching the sub-circles displaying sub-keywords, related to the sub-title keywords 62, to the sub-title circles 60. Such an extension may be enabled as required.

Here, all of the title circles 50 and sub-title circles 60 have the shape of a circle. Since the sub-title circles 60 are attached to the title circles 50, the degrees of relevance may be expressed by different center-to-center distances between the circles. In this regard, the output control module 900 may include a distance controller 980. The distance controller 980 serves to differentially control the distances between the title circles 50 and the sub-title circles 60, depending on the degrees of relevance between the title circles 50 and the sub-title circles 60. Thus, the distance between a title keyword 51 and a sub-title keyword 62 may be relatively short if the degree of relevance therebetween is relatively high, while the distance between the title keyword 51 and the sub-title keyword 62 may be relatively long if the degree of relevance therebetween is relatively low. Here, the title circle 50, in which the title keyword 51 is displayed, acts as a center circle. The distance from the center of the title circle 50 to the center of a specific sub-title circle 60 may be differentially controlled, depending on the degree of relevance between the title keyword 51 and the sub-title keyword 62.

In addition, in this case, a portion of the sub-title circle 60 may overlap a portion of the title circle 50 when the degree of relevance therebetween is relatively high. In this case, a plurality of circles may be connected together, thereby forming another shape. In this regard, the output control module 900 may further include a shape converter 990. The shape converter 990 serves to determine whether or not the title circles 50 overlap the sub-title circles 60, depending on the distances between the title circles 50 and the sub-title circles 60, and to remove a closed curve portion in an overlapping area between the title circles 50 and the sub-title circles 60.

This can be appreciated from the relationship between the title keyword 51 “Acquaintance” and the sub-title keyword 62 “Companion”. Portions of the title circle 50 and the sub-title circle 60 of the title keyword 51 and the sub-title keyword 62 overlap each other. Here, a closed curve portion in the overlapping area is removed, so that the title circle 50 and the sub-title circle 60 are combined and thus are converted into a new shape. According to this configuration, the title circles 50 and the sub-title circles 60, including the title keywords 51 and the sub-title keywords 62 having a high degree of relevance, can be connected and combined, so that the circles can be connected, thereby generating a class having a new shape.

The configurations and functions of the integrated admission data management system using big data analysis according to the present disclosure have been described with reference to the drawings. It should be understood, however, that the foregoing descriptions are illustrative only, and the technical idea of the present disclosure is not limited to the foregoing descriptions or the accompanying drawings. Those having ordinary knowledge in the art will appreciate that various modifications and changes in forms are possible without departing from technical idea of the present disclosure.

What is claimed is:

1. An integrated data management system using a big data model, the system comprising:
one or more processors configured to:
generate the big data model, based on referential information being collected in advance, first data from a plurality of first subscribing devices, and second data from a plurality of second subscribing devices, to be stored in a database;
generate guidance materials being determined using the generated big data model; and
determine at least one second subscribing device having a greatest matching score, to be selected, using the generated big data model, and
a communication processor configured to:
transmit the first data and the guidance materials to the at least one second subscribing device, being selected from the plurality of second subscribing devices; and
provide respective comments and guidance, generated using the big data model and being associated with or modified from the first data, to the plurality of first subscribing devices.

2. The system of claim 1, wherein the one or more processors are further configured to obtain draft personal statements drafted by plural applicants, and personal academic information, as the first data, respectively from the plurality of first subscribing devices.

3. The system of claim 1, wherein the one or more processors are further configured to:
extract keywords from the first data using analytic hierarchy process, in generating the guidance materials; and
perform normalization of information associated with the extracted keywords, using a filtering.

4. The system of claim 3, wherein the one or more processors are further configured to classify the extracted keywords into a plurality of classes by performing a latent class analysis (LCA) on the extracted keywords.

5. The system of claim 4, wherein the one or more processors are further configured to:
estimate recommended terms corresponding to the extracted keywords, based on a determined similarity and/or correlation between the extracted keywords and the recommended terms;
determine an indicator for the classifying; and
apply the recommended terms and the indicator to be included in the generated guidance materials.

6. The system of claim 4, wherein the one or more processors are further configured to assign one value within a predetermined range to be a class number for the classifying.

7. The system of claim 6, wherein the assigned one value is generated and determined to be closest to an estimated maximum likelihood value, being estimated using at least one of Akaike information criterion, Bayesian information criterion, and modified Bayesian information criterion.

8. The system of claim 2, wherein the referential information being collected in advance comprises information related to academic organizations to which the plural applicants are applying for admission.

9. The system of claim 2, wherein the first data from further comprise a respective name of academic organizations to which the plural applicants is respectively applying, and
the first data from further comprise academic grades, award records, comparative activities, letter of recommendation, and student records, respectively for each of the plural applicants.

10. The system of claim 1, wherein the one or more processors are further configured to obtain expertise information, previous experience and portfolio information, academic information, and fee schedules of each of plural experts, as the second data, respectively from the plurality of second subscribing devices, and
wherein the previous experience and portfolio information of each of plural experts further includes a plurality of previously-edited documents that each of plural experts has edited and/or provided comments and feedbacks in the past.

11. The system of claim 1, wherein the communication processor is further configured to:
receive a feedback and/or a recommendation, associated with the first data, from the at least one second subscribing device, being selected from the plurality of second subscribing devices; and
provide the respective comments and guidance, including the received feedback and recommendation and being associated with the first data, to the plurality of first subscribing devices.

12. The system of claim 1, further comprising:
an output control processor configured to:
split a screen of a display into a first area on which a corresponding guidance material is displayed and a second area on which a corresponding draft personal statement is displayed;
differentially output one or more keywords, among a plurality of editing keywords included in the corresponding guidance material, on the first area, depending on contents of the corresponding draft personal statement;
assign one keyword, among the plurality of editing keywords, to be a title keyword;
assign an editing keyword, among the plurality of editing keywords, related to the title keyword, to be a sub-title keyword;
generate a title circle having a shape of a closed circle, in which the title keyword is displayed;
generate a sub-title circle, in which the sub-title keyword is displayed, the sub-title circle being attached to the title circle, being smaller than the title circle, and having a shape of a closed circle; and
display the title circle and the sub-title circle attached to the title circles on the first area, in which the title circle and the sub-title circles are related to the contents of the draft personal statement displayed on the second area.

13. The system of claim 12, wherein the output control processor is further configured to:
differentially control a distance between the title circle and the sub-title circle, depending on a degree of relevance between the title circle and the sub-title circle; and
determine whether or not the title circle overlaps the sub-title circles, depending on the distance between the title circle and the sub-title circle, and removing a closed curve portion in an overlapping area between the title circle and the sub-title circle.

14. The system of claim 1, wherein the one or more processors are further configured to:
create an expert list including expert information and portfolios of a plurality of experts;
provide the expert list to the plurality of first subscribing devices;
allow each of the plurality of first subscribing devices to select one expert among the plurality of experts included in the expert list; and
assign the selected expert to be a corresponding editor for the plurality of first subscribing devices.

15. The system of claim 14, wherein the one or more processors are further configured to:
assign different editing levels to the plurality of experts, respectively, depending on amounts of previously-edited documents by the plurality of experts; and
assign different editing fees depending on the editing levels, and
include the expert information, the portfolios, and the editing fees of the plurality of experts to the created expert list.

16. The system of claim 15, wherein the one or more processors are further configured to:
collect a fee in accordance with the editing level of the expert selected by each of the plurality of first subscribing devices; and
providing a fee for a manuscript to a corresponding second subscribing device for the expert.

17. The system of claim 14, wherein the one or more processors are further configured to:
receive a satisfaction score regarding the editor from a corresponding second subscribing device for an applicant who has received the commented or edited personal statement, and
assign different editing levels to the plurality of experts, respectively, depending on the amounts of the previously-edited documents input by the expert and an average of overall satisfaction scores regarding the expert input to the present point in time.

18. The system of claim 14, wherein the one or more processors are further configured to:
treat the plurality of experts in the expert list with different colors depending on the editing levels of the plurality of experts.

19. The system of claim 14, wherein the one or more processors are further configured to generate the big data model by integrating the referential information being collected in advance, the first data from the plurality of first subscribing devices, and the second data from the plurality of second subscribing devices, to be stored in a database.

20. A processor-implemented integrated data management method using a big data model, the method comprising:
generating, by one or more processors, the big data model, based on referential information being collected in advance, first data from a plurality of first subscribing devices, and second data from a plurality of second subscribing devices, to be stored in a database;
generating, by the one or more processors, guidance materials being determined using the generated big data model;
determining, by the one or more processors, at least one second subscribing device having a greatest matching score, to be selected, using the generated big data model;
transmitting, by a communication processor, the first data and the guidance materials to the at least one second subscribing device, being selected from the plurality of second subscribing devices; and
providing, by the one or more processors, respective comments and guidance, generated using the big data model and being associated with or modified from the first data, to the plurality of first subscribing devices.
